(19) United States
(12) Patent Application Publication
(10) Pub. No.: US 2024/0008062 A1
(43) Pub. Date: Jan. 4, 2024

(54) CHANNEL SWITCH IN A WIRELESS NETWORK

(71) Applicant: NXP USA, Inc., AUSTIN, TX (US)

(72) Inventors: Liwen Chu, San Ramon, CA (US); Hongyuan Zhang, Fremont, CA (US); Kiseon Ryu, McLean, VA (US)

(21) Appl. No.: 18/216,495

(22) Filed: Jun. 29, 2023

Related U.S. Application Data
(60) Provisional application No. 63/367,314, filed on Jun. 29, 2022.
(60) Provisional application No. 63/373,746, filed on Aug. 29, 2022.

(51) Int. Cl. H04W 72/51; H04W 72/04

(52) U.S. Cl. CPC H04W 72/51; H04W 72/04; H04W 88/10

(57) ABSTRACT

Embodiments of a method and apparatus for wireless communications are disclosed. In an embodiment, a wireless device includes a wireless transceiver configured to communicate with a first device that is compatible with a first wireless communications protocol and a second device that is compatible with a second wireless communications protocol and a controller configured to announce different channel configurations for the first device that is compatible with the first wireless communications protocol and the second device that is compatible with the second wireless communications protocol when performing channel switch.

### CROSS-REFERENCE TO RELATED APPLICATIONS

This application is entitled to the benefit of U.S. Provisional Patent Application Ser. No. 63/367,314, filed on Jun. 29, 2022, and U.S. Provisional Patent Application Ser. No. 63/373,746, filed on Aug. 29, 2022, each of which is incorporated by reference herein.

### BACKGROUND

Wireless communications devices, e.g., wireless access points (APs) or non-AP devices can transmit various types of information using different transmission techniques. For example, an AP can announce its channel switch to advertise when it is switching from a current communications channel to a new communications channel, for example, through Channel Switch Extended Channel Switch based on Institute of Electrical and Electronics Engineers (IEEE) 802.11 family of standards (e.g., Wi-Fi standards). Within a typical AP multi-link device (MLD), if a first AP announces its channel switch (e.g., to reduce interference and/or to improve communications speed and connectivity), a second AP can also announce the first AP's channel switch. However, typical channel switch techniques generally require identical bandwidth (BW) values for all station (STA) devices and cannot handle different BW values for different types of STA devices (e.g., STA devices that are compatible with different IEEE 802.11 standards (e.g., Wi-Fi standards)). For example, typical channel switch techniques generally cannot handle different BW values for extremely high-throughput (EHT) STAs that are compatible with IEEE 802.11be standards, High-Efficiency (HE) STAs that are compatible with IEEE 802.11ax standards, and Very High Throughput (VHT) STAs that are compatible with IEEE 802.11ac standards.

### SUMMARY

Embodiments of a method and apparatus for wireless communications are disclosed. In an embodiment, a wireless device includes a wireless transceiver configured to communicate with a first device that is compatible with a first wireless communications protocol and a second device that is compatible with a second wireless communications protocol and a controller configured to announce different channel configurations for the first device that is compatible with the first wireless communications protocol and the second device that is compatible with the second wireless communications protocol when performing channel switch. Other embodiments are also disclosed.

In an embodiment, the controller is configured to announce different channel bandwidth configurations of a channel being switched to for the first device that is compatible with the first wireless communications protocol and the second device that is compatible with the second wireless communications protocol.

In an embodiment, the controller is configured to announce different channel puncture configurations of a channel being switched to for the first device that is compatible with the first wireless communications protocol and the second device that is compatible with the second wireless communications protocol when performing channel switch.

In an embodiment, the controller is configured to announce different channel transmit power information of a channel being switched to for the first device that is compatible with the first wireless communications protocol and the second device that is compatible with the second wireless communications protocol when performing channel switch.

In an embodiment, the controller is configured to announce the different channel configurations for the first device that is compatible with the first wireless communications protocol and the second device that is compatible with the second wireless communications protocol in an Enhanced Wide Bandwidth Channel Switch element.

In an embodiment, the controller is configured to announce the different channel configurations for the first device that is compatible with the first wireless communications protocol and the second device that is compatible with the second wireless communications protocol in an Enhanced Channel Switch Wrapper element.

In an embodiment, the controller is configured to announce the different channel configurations for the first device that is compatible with the first wireless communications protocol and the second device that is compatible with the second wireless communications protocol in an Enhanced Wide Bandwidth Channel Switch element and in a Wide Bandwidth Channel Switch element.

In an embodiment, the controller is configured to announce the different channel configurations for the first device that is compatible with the first wireless communications protocol and the second device that is compatible with the second wireless communications protocol in an Enhanced Channel Switch Wrapper element and in a Channel Switch Wrapper element.

In an embodiment, the first wireless communications protocol includes an IEEE 802.11 protocol.

In an embodiment, the first wireless communications protocol includes an IEEE 802.11be protocol.

In an embodiment, the wireless device is a component of a multi-link device (MLD).

In an embodiment, the wireless device is a wireless access point (AP).

In an embodiment, a wireless access point (AP) of a first multi-link device (MLD) includes a wireless transceiver configured to receive and transmit communications data with a first device that is compatible with a first IEEE 802.11 protocol and a second device that is compatible with a second IEEE 802.11 protocol of a second MLD, and a controller configured to announce different channel configurations of a channel being switched to for the first device that is compatible with the first IEEE 802.11 protocol and the second device that is compatible with the second IEEE 802.11 protocol when performing channel switch.

In an embodiment, the controller is configured to announce different channel bandwidth configurations of the channel being switched to for the first device that is compatible with the first IEEE 802.11 protocol and the second device that is compatible with the second IEEE 802.11 protocol.

In an embodiment, the controller is configured to announce different channel puncture configurations of the channel being switched to for the first device that is compatible with the first IEEE 802.11 protocol and the second device that is compatible with the second IEEE 802.11 protocol when performing channel switch.

In an embodiment, the controller is configured to announce different channel transmit power information of the channel being switched to for the first device that is compatible with the first IEEE 802.11 protocol and the second device that is compatible with the second IEEE 802.11 protocol when performing channel switch.

In an embodiment, the controller is configured to announce the different channel configurations of the channel being switched to for the first device that is compatible with the first IEEE 802.11 protocol and the second device that is compatible with the second IEEE 802.11 protocol in an Enhanced Wide Bandwidth Channel Switch element.

In an embodiment, the controller is configured to announce the different channel configurations of the channel being switched to for the first device that is compatible with the first IEEE 802.11 protocol and the second device that is compatible with the second IEEE 802.11 protocol in an Enhanced Channel Switch Wrapper element.

In an embodiment, a method for wireless communications involves communicating with a first device that is compatible with a first wireless communications protocol and a second device that is compatible with a second wireless communications protocol and announcing different channel configurations for the first device that is compatible with the first wireless communications protocol and the second device that is compatible with the second wireless communications protocol when performing channel switch.

In an embodiment, announcing the different channel configurations for the first device that is compatible with the first wireless communications protocol and the second device that is compatible with the second wireless communications protocol when performing channel switch includes announcing different channel bandwidth configurations of a channel being switched to for the first device that is compatible with the first wireless communications protocol and the second device that is compatible with the second wireless communications protocol.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a multi-link communications system.

FIG. 2 depicts an example format of an EHT Operation element.

FIG. 3 depicts an example format of an Enhanced Wide Bandwidth Channel Switch element.

FIG. 4 depicts an example format of an Enhanced Channel Switch Wrapper element.

FIG. 5 depicts an example format of an Enhanced Wide Bandwidth Channel Switch element.

FIG. 6 depicts an example format of an Enhanced Channel Switch Wrapper element.

FIG. 7 depicts an example format of a Channel Switch announcement element.

FIG. 8 depicts an example format of a Wide Bandwidth Channel Switch element.

FIG. 9 depicts an example format of a Channel Switch Wrapper element.

FIG. 10 depicts a wireless device in accordance with an embodiment of the invention.

FIG. 11 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

In embodiments of a wireless communications system, a wireless device, e.g., an access point (AP) multi-link device (MILD) of a wireless local area network (WLAN) may transmit data to at least one associated station (STA) MLD. The AP MLD may be configured to operate with associated STA MLDs according to a communication protocol. For example, the communication protocol may be an Extremely High Throughput (EHT) communication protocol, or Institute of Electrical and Electronics Engineers (IEEE) 802.11be communication protocol. Features of wireless communications and multi-link communication systems operating in accordance with the EHT communication protocol and/or next-generation communication protocols may be referred to herein as “non-legacy” features. In some embodiments of the wireless communications system described herein, different associated STAs within range of an AP operating according to the EHT communication protocol are configured to operate according to at least one other communication protocol, which defines operation in a Basic Service Set (BSS) with the AP, but are generally affiliated with lower data throughput protocols. The lower data throughput communication protocols (e.g., High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

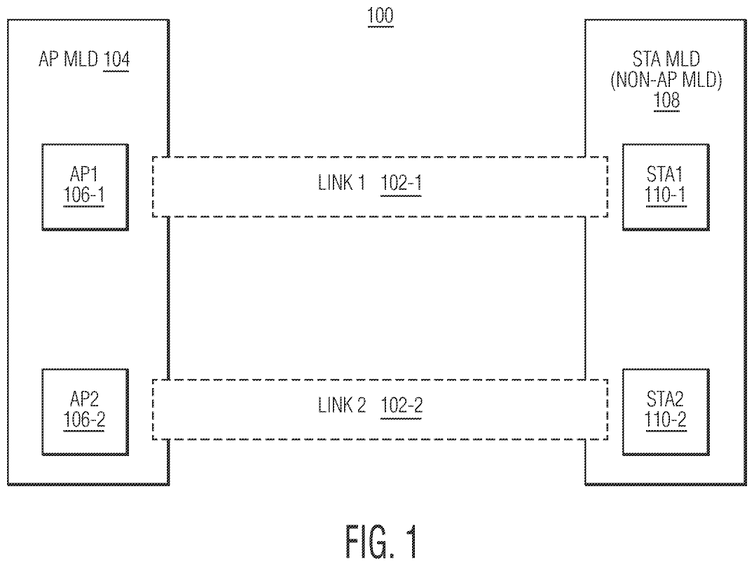

FIG. 1 depicts a multi-link communications system 100 that is used for wireless (e.g., WiFi) communications. In the embodiment depicted in FIG. 1, the multi-link communications system includes one AP multi-link device, which is implemented as AP MILD 104, and one non-AP STA multi-link device, which is implemented as STA MLD 108. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11be protocol. Although the depicted multi-link communications system 100 is shown in FIG. 1 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-HE STAs) associate with one of the APs affiliated with the AP MLD. In another example, although the multi-link communications system is shown in FIG. 1 as being connected in a certain topology, the network topology of the multi-link communications system is not limited to the topology shown in FIG. 1.

In the embodiment depicted in FIG. 1, the AP MLD 104 includes two radios, implemented as APs 106-1 and 106-2. In such an embodiment, the APs may be AP1 106-1 and AP2 106-2. In some embodiments, a common part of the AP MLD 104 implements upper layer Media Access Control (MAC) functionalities (e.g., beaconing, association establishment, reordering of frames, etc.) and a link specific part of the AP MLD 104, i.e., the APs 106-1 and 106-2, implement lower layer MAC functionalities (e.g., backoff, frame transmission, frame reception, etc.). The APs 106-1 and 106-2 may be implemented in hardware (e.g., circuits), software, firmware, or a combination thereof. The APs 106-1 and 106-2 may be fully or partially implemented as an integrated circuit (IC) device. In some embodiments, the APs 106-1 and 106-2 may be wireless APs compatible with at least one WLAN communications protocol (e.g., at least one IEEE 802.11 protocol). For example, the APs 106-1 and 106-2 may be wireless APs compatible with the IEEE 802.11be protocol.

In some embodiments, an AP MLD (e.g., AP MLD 104) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 106-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 106-1 or 106-2 of the AP MLD 104 may operate in a different BSS operating channel. For example, AP1 106-1 may operate in a 320 MHz (one million hertz) BSS operating channel at 6 Gigahertz (GHz) band and AP2 106-2 may operate in a 160 MHz BSS operating channel at 5 GHz band. Although the AP MLD 104 is shown in FIG. 1 as including two APs, other embodiments of the AP MLD 104 may include more than two APs.

In the embodiment depicted in FIG. 1, the non-AP STA multi-link device, implemented as STA MLD 108, includes two radios which are implemented as non-AP STAs 110-1 and 110-2. In such an embodiment, the non-AP STAs may be STA1 110-1 and STA2 110-2. The STAs 110-1 and 110-2 may be implemented in hardware (e.g., circuits), software, firmware, or a combination thereof. The STAs 110-1 and 110-2 may be fully or partially implemented as an IC device. In some embodiments, the non-AP STAs 110-1 and 110-2 are part of the STA MLD 108, such that the STA MLD may be a communications device that wirelessly connects to a wireless AP MLD. For example, the STA MLD 108 may be implemented in a laptop, a desktop personal computer (PC), a mobile phone, or other communications device that supports at least one WLAN communications protocol. In some embodiments, the non-AP STA MLD 108 is a communications device compatible with at least one IEEE 802.11 protocol (e.g., an IEEE 802.11be protocol, an IEEE 802.11ax protocol, or an IEEE 802.11ac protocol). In some embodiments, the STA MLD 108 implements a common MAC data service interface and the non-AP STAs 110-1 and 110-2 implement a lower layer MAC data service interface.

In some embodiments, the AP MLD 104 and/or the STA MLD 108 may identify which communication links support multi-link operation during a multi-link operation setup phase and/or exchanges information regarding multi-link capabilities during the multi-link operation setup phase. In some embodiments, each of the non-AP STAs 110-1 and 110-2 of the STA MLD 108 may operate in a different frequency band. For example, the non-AP STA 110-1 may operate in the 2.4 GHz frequency band and the non-AP STA 110-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 1, the STA MLD 108 communicates with the AP MLD 104 via two communication links, e.g., link 1 102-1 and link 2 102-2. For example, each of the non-AP STAs 110-1 or 110-2 communicates with an AP 106-1 or 106-2 via corresponding communication links 102-1 or 102-2. In an embodiment, a communication link (e.g., link 1 102-1 or link 2 102-2) may include a BSS operating channel established by an AP (e.g., AP1 106-1 or AP2 106-2) that features multiple 20 MHz channels used to transmit frames (e.g., Physical Layer Convergence Protocol (PLCP) Protocol Data Units (PPDUs), Beacon frames, management frames, etc.) between a first wireless device (e.g., an AP, an AP MLD, an STA, or an STA MLD) and a second wireless device (e.g., an AP, an AP MLD, an STA, or an STA MLD). In some embodiments, a 20 MHz channel may be a punctured 20 MHz channel or an unpunctured 20 MHz channel. Although the STA MLD 108 is shown in FIG. 1 as including two non-AP STAs, other embodiments of the STA MLD 108 may include one non-AP STA or more than two non-AP STAs. In addition, although the AP MLD 104 communicates (e.g., wirelessly communicates) with the STA MLD 108 via multiple links 102-1 and 102-2, in other embodiments, the AP MLD 104 may communicate (e.g., wirelessly communicate) with the STA MLD 108 via more than two communication links or less than two communication links.

In some embodiments, a first MLD, e.g., an AP MLD or non-AP MLD (STA MLD), may transmit management frames in a multi-link operation with a second MLD, e.g., STA MLD or AP MLD, to coordinate the multi-link operation between the first MLD and the second MILD. As an example, a management frame may be a channel switch announcement frame, a (Re)Association Request frame, a (Re)Association Response frame, a Beacon frame, a Disassociation frame, an Authentication frame, and/or a Block Acknowledgement (Ack) (BA) Action frame, etc. In some embodiments, one or more management frames may be transmitted via a cross-link transmission (e.g., according to an IEEE 802.11be communication protocol). As an example, a cross-link management frame transmission may involve a management frame being transmitted and/or received on one link (e.g., link 1 102-1) while carrying information of another link (e.g., link 2 102-2). In some embodiments, a management frame is transmitted on any link (e.g., at least one of two links or at least one of multiple links) between a first MLD (e.g., AP MLD 104) and a second MLD (e.g., STA MLD 108). As an example, a management frame may be transmitted between a first MLD and a second MLD on any link (e.g., at least one of two links or at least one of multiple links) associated with the first MLD and the second MLD. In some embodiments, a channel switch announcement frame contains information regarding wireless communications channel to be used, which may include channel frequency information, channel bandwidth (BW) information, channel puncture information, and/or the allowed transmit power information. In some embodiments, a signaling channel punctures a traffic channel whenever collision occurs such that data is not sent on the traffic channel in the portion of time-frequency blocks that collide with time-frequency sections for the signaling channel. In some embodiments, a signaling allowed transmit power information announces the allowed transmit power used by the associated STA.

In some embodiments, an AP that is compatible with a first wireless communications protocol and a second wireless communications protocol can announce different communications or operating channel configurations for STAs that are compatible with the first wireless communications protocol and STAs that are compatible with the second wireless communications protocol when performing channel switch. The AP can use channel switch announcement to advertise or notify connected stations of its intention to change the communications/operating channel and the channel number of the new communications/operating channel, which allows clients/STAs to switch or hop to the new communications/operating channel in which the AP is switching to and maintain the connections, for example, to reduce interference and/or to improve communications speed and connectivity. In some embodiments, an AP can announce different communications or operating channel configurations for STAs that are compatible with a first wireless communications protocol (e.g., non-legacy STAs) and STAs that are incompatible with the first wireless communications protocol (e.g., legacy STAs) when performing channel switch from a current communications/operating channel to a new communications/operating channel. For example, an EHT AP that is compatible with IEEE 802.11be protocols can announce different communications or operating channel configurations for EHT STAs that are compatible with IEEE 802.11be protocols and non-EHT STAs that are incompatible with IEEE 802.11be protocols (e.g., High-Efficiency (HE) STAs that are compatible with IEEE 802.11ax protocols or Very High Throughput (VHT) STAs that are compatible with IEEE 802.11ac standards) when performing channel switch. In some embodiments, different new BSS operating channel transmit (Tx) power information is announced for 1T STAs and non-EHT STAs if different BSS operating channels are announced for EHT STAs and non-EHT STAs. In some embodiments, within an AP MLD (e.g., AP MLD 104), if a first AP (e.g., AP 106-1) announces its channel switch with different BW channels, a second AP (e.g., AP 106-2) also announces the first AP's channel switch with different BW channels through, for example, a basic ML element. In some embodiments, a wider BW channel is announced in a new defined element, and channel puncture information (e.g., 20 MHz channel puncture information) is announced in a new defined element. Thus, frame formats and transmission techniques for channel switch management frames may need to be defined for MLDs (e.g., for MLDs operating in accordance with an 802.11be communication protocol). Techniques for channel switch management frame transmissions are described herein.

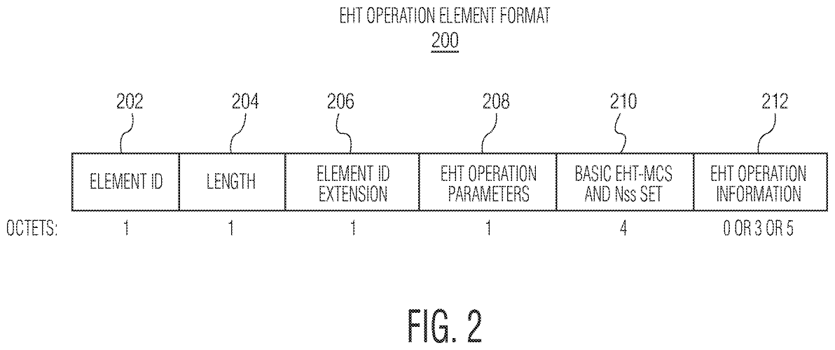

In some embodiments, an EHT AP that is compatible with an IEEE 802.11be protocol can announce the static channel puncture through an EHT Operation element. The Channel Width in the EHT Operation element can be different from the Channel Width in a HE/VHT Operation element when some 20 MHz channel of BSS operating channel are punctured, or when the Channel width in the EHT Operation element is not supported in HE/VHT devices. FIG. 2 depicts an example format of an EHT Operation element 200. In the embodiment depicted in FIG. 2, the EHT Operation element 200 includes an element identification (ID) field 202 (e.g., one-octet) that may contain identification information regarding which specific element this element represents, an element length field 204 (e.g., one-octet) that may contain element length information, an element ID extension field 206 (e.g., one-octet) that may contain ID extension information, an EHT Operation Parameters field 208 (e.g., one-octet) that may contain EHT Operation Parameters, a basic EHT-Modulation Coding Scheme (MCS) and Network Security Services (Nss) set field 210 (e.g., four-octet) that may contain corresponding MCS and Nss information, and an optional EHT operation information field 212 (e.g., zero-octet, three-octet or five-octet) that may contain EHT operation information. In some embodiments, the EHT Operation element 200 further includes some reserved (sub)field.

In some embodiments, when channel switch from a current communications/operating channel to a new communications/operating channel is done by an EHT AP that is compatible with an IEEE 802.11be protocol, the new communications/operating channel (i.e., a channel being switched to or a switched channel) is allowed to include punctured 20 MHz channels and/or have 320 MHz bandwidth. In some embodiments, in Beacon, Probe Response, Channel Switch Announcement and Extended Channel Switch Announcement frame, the different channel width, punctured channel information, transmission (Tx) power information of the new channel (channel being switched to in the future) are announced. In some embodiments, an EHT STA that is compatible with an IEEE 802.11be protocol and a non-EHT STA that is not compatible with an IEEE 802.11be protocol acquire different BSS bandwidth (BW), channel puncture per the announcement.

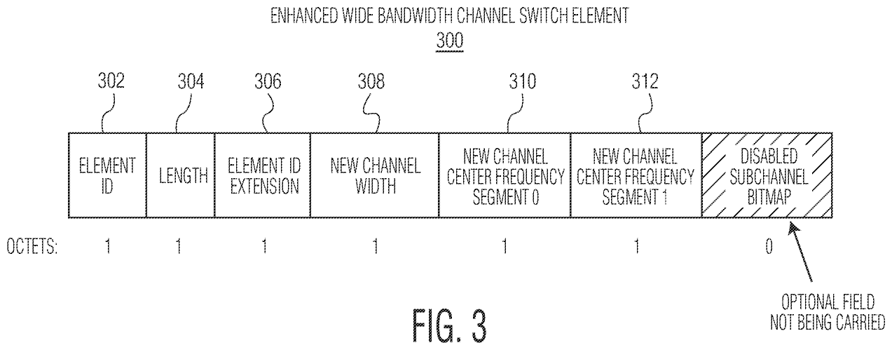

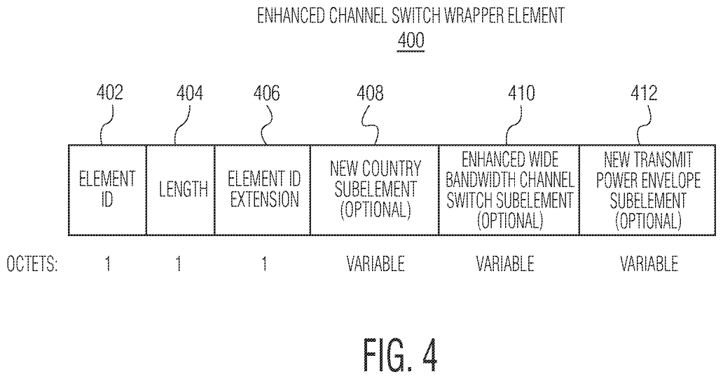

In some embodiments, an EHT AP that is compatible with an IEEE 802.11be protocol announces different BWs of a new communications/operating channel (i.e., a channel being switched to (also referred to as a switched channel)) for EHT STAs that are compatible with IEEE 802.11be protocols and HE/VHT STAs that are not compatible with IEEE 802.11be protocols. When the switched channel does not have punctured 20 MHz channels and the switched channel is not more than 160 MHz, a single switched channel may be announced. When the switched channel is 320 MHz and the primary 160 MHz channel has no punctured 20 MHz channel(s), the Wide Channel Switch element may announce 160 MHz BW. One or more new defined elements may announce 320 MHz channel bandwidth and transmit power information. FIG. 3 depicts an example format of a new defined element, which is an Enhanced Wide Bandwidth Channel Switch element 300. In the embodiment depicted in FIG. 3, the Enhanced Wide Bandwidth Channel Switch element 300 includes an element identification (ID) field 302 (e.g., one-octet) that may contain identification information regarding which specific element this element represents, an element length field 304 (e.g., one-octet) that may contain element length information, an element ID extension field 306 (e.g., one-octet) that may contain ID extension information, a new channel width field 308 (e.g., one-octet) that may contain channel width information for the new channel that is being switched to, a new channel center frequency segment 0 field 310 (e.g., one-octet) that may contain channel center frequency information for the new channel that is being switched to, and a new channel center frequency segment 1 field 312 (e.g., one-octet) that may contain additional channel center frequency information for the new channel that is being switched to. An optional Disabled Subchannel Bitmap field that contains information regarding a disabled subchannel bitmap is not included in the Enhanced Wide Bandwidth Channel Switch element 300 because no punctured channel is used. In some embodiments, the Enhanced Wide Bandwidth Channel Switch element 300 further includes some reserved (sub)field. FIG. 4 depicts an example format of an Enhanced Channel Switch Wrapper element 400 that may contain subelements that indicate characteristics of a BSS after a channel switch from a current communications/operating channel to a new communications/operating channel. In the embodiment depicted in FIG. 4, the Enhanced Channel Switch Wrapper element 400 includes an element identification (ID) field 402 (e.g., one-octet) that may contain identification information regarding which specific element this element represents, an element length field 404 (e.g., one-octet) that may contain element length information, an element ID extension field 406 (e.g., one-octet) that may contain ID extension information, an optional new country subelement 408 with variable length that may be present when an AP or mesh STA performs extended channel switching to a new Country, new Operating Class Table, or a changed set of operating classes relative to the contents of a Country element sent in a Beacon, an optional Enhanced Wide Bandwidth Channel Switch subelement 410 with variable length that may contain the same or similar information as the Enhanced Wide Bandwidth Channel Switch element 300 depicted in FIG. 3, and a New Transmit Power Envelope subelement 412 that may contain a distinct value of a Local Maximum Transmit Power Unit Interpretation subfield. In some embodiments, each New Transmit Power Envelope subelement indicates the regulatory or local maximum transmit powers for the BSS for the indicated bandwidths with an indicated unit interpretation after channel switch. In some embodiments, the Enhanced Channel Switch Wrapper element 400 further includes some reserved (sub)field.

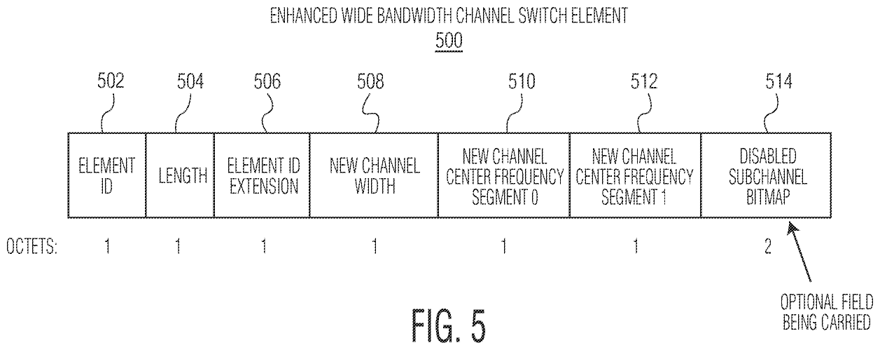

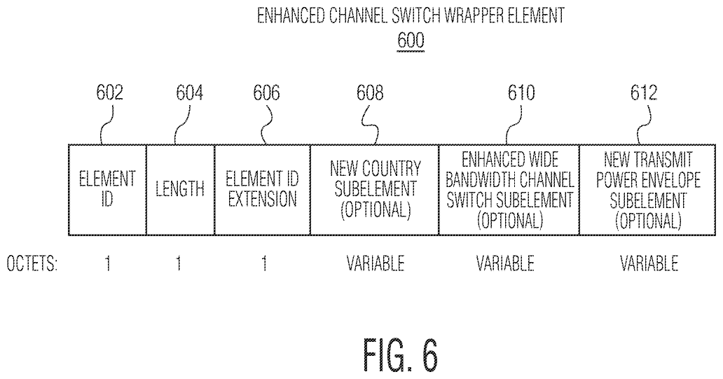

In some embodiments, an EHT AP that is compatible with an IEEE 802.11be protocol announces different BWs of a new communications/operating channel (i.e., a channel being switched to (also referred to as a switched channel)) for EHT STAs that are compatible with IEEE 802.11be protocols and HE/VHT STAs that are not compatible with IEEE 802.11be protocols. In some embodiments, when the switched channel includes punctured 20 MHz channel(s), the Wide Channel Switch element announces the widest channel width that includes the primary 20 MHz channel and does not include any punctured 20 MHz channels. The new defined element(s) may announce channel bandwidth that includes punctured 20 MHz channel(s), Punctured Channel Bitmap and transmit power information. FIG. 5 depicts an example format of an Enhanced Wide Bandwidth Channel Switch element 500. In the embodiment depicted in FIG. 5, the Enhanced Wide Bandwidth Channel Switch element 500 includes an element ID field 502 (e.g., one-octet) that may contain identification information regarding which specific element this element represents, an element length field 504 (e.g., one-octet) that may contain element length information, an element ID extension field 506 (e.g., one-octet) that may contain ID extension information, a new channel width field 508 (e.g., one-octet) that may contain channel width information for the new channel that is being switched to, a new channel center frequency segment 0 field 510 (e.g., one-octet) that may contain channel center frequency information for the new channel that is being switched to, a new channel center frequency segment 1 field 512 (e.g., one-octet) that may contain additional channel center frequency information for the new channel that is being switched to, and an optional Disabled Subchannel Bitmap field 514 (e.g., two-octet) that may contain information regarding a disabled subchannel bitmap. In some embodiments, the Enhanced Wide Bandwidth Channel Switch element 500 further includes some reserved (sub)field. FIG. 6 depicts an example format of an Enhanced Channel Switch Wrapper element 600 that may contain subelements that indicate characteristics of a BSS after a channel switch from a current communications/operating channel to a new communications/operating channel. In the embodiment depicted in FIG. 6, the Enhanced Channel Switch Wrapper element 600 includes an element identification (ID) field 602 (e.g., one-octet) that may contain identification information regarding which specific element this element represents, an element length field 604 (e.g., one-octet) that may contain element length information, an element ID extension field 606 (e.g., one-octet) that may contain ID extension information, an optional new country subelement 608 with variable length that may be present when an AP or mesh STA performs extended channel switching to a new Country, new Operating Class Table, or a changed set of operating classes relative to the contents of a Country element sent in a Beacon, an optional Enhanced Wide Bandwidth Channel Switch subelement 610 with variable length that may contain the same or similar information as the Enhanced Wide Bandwidth Channel Switch element 500 depicted in FIG. 5, and a New Transmit Power Envelope subelement 612 that may contain a distinct value of a Local Maximum Transmit Power Unit Interpretation subfield. In some embodiments, each New Transmit Power Envelope subelement indicates the regulatory or local maximum transmit powers for the BSS for the indicated bandwidths with an indicated unit interpretation after channel switch. In some embodiments, the Enhanced Channel Switch Wrapper element 600 further includes some reserved (sub)field.

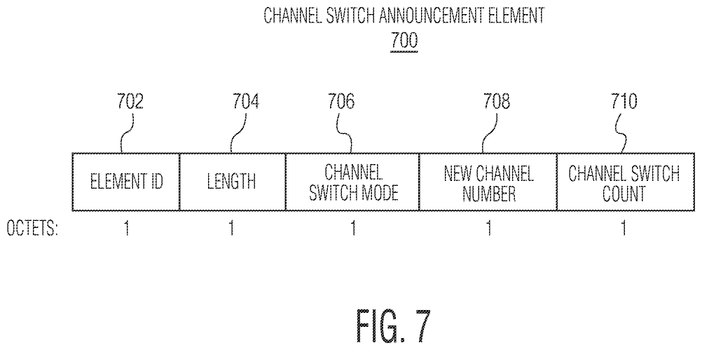

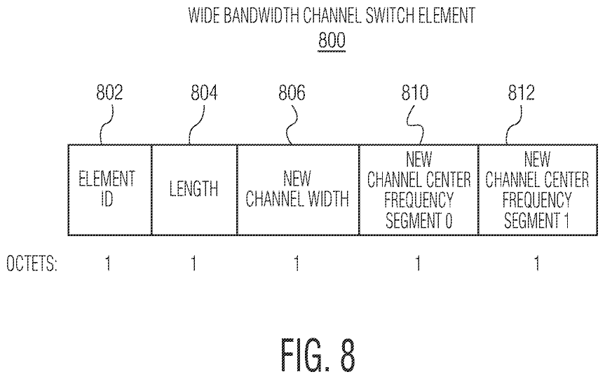

In some embodiments, an EHT AP that is compatible with an IEEE 802.11be protocol announces a channel switch to 320 MHz without static channel puncture. In some embodiments, in a Beacon frame and other related management frames, e.g., Probe Response, Channel Switch Announcement, Extended Channel Switch Announcement besides Channel Switch Announcement element, both Wide Bandwidth Channel Switch element that indicates 160 MHz channel and Enhanced Wide Bandwidth Channel Switch element (e.g., the Enhanced Wide Bandwidth Channel Switch element 300 depicted in FIG. 3) that indicates 320 MHz channel are carried. FIG. 7 depicts an example format of a Channel Switch announcement element 700. In the embodiment depicted in FIG. 7, the Channel Switch announcement element 700 includes an element ID field 702 (e.g., one-octet) that may contain identification information regarding which specific element this element represents, an element length field 704 (e.g., one-octet) that may contain element length information, a channel switch mode field 706 (e.g., one-octet) that may contain information that indicates any restrictions on transmission until a channel switch, a new channel number field 708 (e.g., one-octet) that may be the number of the new channel that is being switched to, and a channel switch count field 710 that may contain channel switch count information. In some embodiments, for non-mesh STAs, the Channel Switch Count field is set to the number of Target Beacon Transmission Time (TBTT) until the STA sending the Channel Switch Announcement element switches to the new channel. For example, the value 1 indicates that the switch occurs at the next TBTT (the ensuing Beacon frame is created assuming the new channel), and the value 0 indicates that the switch occurs at any time after the frame containing the element is transmitted. In some embodiments, for mesh STAs, the Channel Switch Count field is encoded as an octet with bits 6 to 0 set to the time, in of 2 time unit (TU) (one TU being a unit of time equal to 1024 microseconds) when the most significant bit (MSB) (bit 7) is 0, or in units of 100 TU when the MSB (bit 7) is 1, until the mesh STA sending the Channel Switch Announcement element switches to the new channel. In some embodiments, the Channel Switch announcement element 700 further includes some reserved (sub)field. FIG. 8 depicts an example format of a Wide Bandwidth Channel Switch element 800. In the embodiment depicted in FIG. 8, the Wide Bandwidth Channel Switch element 800 includes an element identification (ID) field 802 (e.g., one-octet) that may contain identification information regarding which specific element this element represents, an element length field 804 (e.g., one-octet) that may contain element length information, a channel switch mode field 806 (e.g., one-octet) that may contain information that indicates any restrictions on transmission until a channel switch, a new channel center frequency segment 0 field 810 (e.g., one-octet) that may contain channel center frequency information for the new channel that is being switched to, and a new channel center frequency segment 1 field 812 (e.g., one-octet) that may contain additional channel center frequency information for the new channel that is being switched to. In some embodiments, the Wide Bandwidth Channel Switch element 800 further includes some reserved (sub)field.

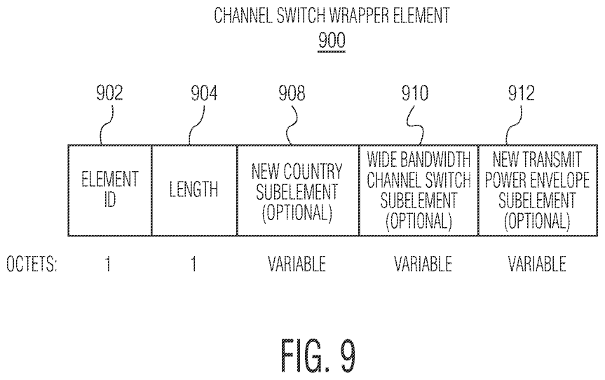

In some embodiments, an EHT AP that is compatible with an IEEE 802.11be protocol announces the channel switch to 320 MHz without static channel puncture where the new channel's Tx power is announced. In some embodiments, in Beacon frame and other related management frames, e.g., Probe Response, Channel Switch Announcement, Extended Channel Switch Announcement, besides Channel Switch Announcement element, both Channel Switch Wrapper element that indicates 160 MHz channel and the related Tx power and Enhanced Channel Switch Wrapper element (e.g., the Enhanced Channel Switch Wrapper element 400 depicted in FIG. 4) that indicates 320 MHz channel and related Tx power are carried. FIG. 9 depicts an example format of a Channel Switch Wrapper element 900 that may contain subelements that indicate characteristics of a BSS after a channel switch. In the embodiment depicted in FIG. 9, the Channel Switch Wrapper element 900 includes an element identification (ID) field 902 (e.g., one-octet) that may contain identification information regarding which specific element this element represents, an element length field 904 (e.g., one-octet) that may contain element length information, an optional new country subelement 908 with variable length that may be present when an AP or mesh STA performs extended channel switching to a new Country, new Operating Class Table, or a changed set of operating classes relative to the contents of a Country element sent in a Beacon, an optional Wide Bandwidth Channel Switch subelement 910 with variable length that may contain the same or similar information as the Wide Bandwidth Channel Switch element 800 depicted in FIG. 8, and a New Transmit Power Envelope subelement 912 that may contain a distinct value of a Local Maximum Transmit Power Unit Interpretation subfield. In some embodiments, each New Transmit Power Envelope subelement indicates the local maximum transmit powers for the BSS for the indicated bandwidths with an indicated unit interpretation after channel switch from a current communications/operating channel to a new communications/operating channel. In some embodiments, the Channel Switch Wrapper element 900 further includes some reserved (sub)field.

In some embodiments, an EHT AP that is compatible with an IEEE 802.11be protocol announces the channel switch to 160 MHz with static channel puncture in secondary 80 MHz channel. In some embodiments, in Beacon frame besides Channel Switch Announcement element, both Wide Bandwidth Channel Switch element (e.g., the Wide Bandwidth Channel Switch element 800 depicted in FIG. 8) that indicates 80 MHz channel and Enhanced Wide Bandwidth Channel Switch element (e.g., the Enhanced Wide Bandwidth Channel Switch element 500 depicted in FIG. 5) that indicates 160 MHz channel are carried.

In some embodiments, an EHT AP that is compatible with an IEEE 802.11be protocol announces the channel switch to 160 MHz with static channel puncture in secondary 80 MHz channel where the new channel's Tx power is announced. In some embodiments, in Beacon frame besides Channel Switch Announcement element, both Channel Switch Wrapper element (e.g., the Channel Switch Wrapper element 900 depicted in FIG. 9) that indicates 80 MHz channel and the related Tx power and Enhanced Channel Switch Wrapper element (e.g., the Enhanced Channel Switch Wrapper element 600 depicted in FIG. 6) that indicates 160 MHz channel with punctured channel indication and related Tx power are carried.

In some embodiments, an EHT AP that is compatible with an IEEE 802.11be protocol announces the channel switch to 160 MHz with static channel puncture in secondary 80 MHz channel. In some embodiments, if the EHT AP does not allow non-EHT STAs to associate with it, in Beacon frame besides Channel Switch Announcement element, Enhanced Wide Bandwidth Channel Switch element that indicates 160 MHz channel are carried. In these embodiments, the Wide Bandwidth Channel Switch element that indicates 80 MHz channel is not carried.

In some embodiments, an EHT AP that is compatible with an IEEE 802.11be protocol announces the channel switch to 160 MHz with static channel puncture in secondary 80 MHz channel where the new channel's Tx power is announced. In some embodiments, if the EHT AP does not allow non-EHT STAs to associate with it, in Beacon frame besides Channel Switch Announcement element, the related Tx power and Enhanced Channel Switch Wrapper element that indicates 160 MHz channel with punctured channel indication and related Tx power are carried. In these embodiments, the Channel Switch Wrapper element that indicates 80 MHz channel is not carried.

Some example of channel Switch Announcement Usage by EHT STAs that are compatible with an IEEE 802.11be protocol are described as follows. In some embodiments, if the received Beacon, Probe Response etc. contains neither Enhanced Wide Bandwidth Channel Switch element nor Enhanced Channel Switch Wrapper element, an EHT/non-EHT STA uses the received (Extended) Channel Switch Announcement element, Wide Bandwidth Channel Switch element, Channel Switch Wrapper element to decide the new channel and/or the regulatory/local transmit power restriction. The EHT STA may use the new channel and/or the regulatory/local transmit power restriction decided by (Extended) Channel Switch Announcement element, Wide Bandwidth Channel Switch element, Channel Switch Wrapper element to transmit/receive PPDUs from/to a corresponding AP. In some embodiments, if the received Beacon, Probe Response etc. contains at least one of Enhanced Wide Bandwidth Channel Switch element and Enhanced Channel Switch Wrapper element, an EHT STA uses the received Enhanced Wide Bandwidth Channel Switch element and Enhanced Channel Switch Wrapper element and (Extended) Channel Switch Announcement element to decide the new channel and/or the regulatory/local transmit power restriction. A non-EHT STA may use the received (Extended) Channel Switch Announcement element, Wide Bandwidth Channel Switch element, Channel Switch Wrapper element to decide the new channel and/or the regulatory/local transmit power restriction. In some embodiments, the non-EHT STA uses the new channel and/or the regulatory/local transmit power restriction decided by (Extended) Channel Switch Announcement element, Enhanced Wide Bandwidth Channel Switch element, Enhanced Channel Switch Wrapper element to transmit/receive PPDUs from/to a corresponding AP.

The (Extended) Channel Switch Announcement element can be carried in multi-link (ML) element for reported APs. However, the (Extended) Channel Switch Announcement element may not give the full information of the new channel. In some embodiments, the Per STA Profile of an ML element related to a reported AP carries the Wider Bandwidth Channel Switch element, Channel Switch Wrapper element, Enhanced Wider Bandwidth Channel Switch element, Enhanced Switch Wrapper element if the related element is carried in the Beacon transmitted by the reported AP in its working link or inherited from the transmitted Basic Service Set Identifier (BSSID) AP in the same multiple BSSID set as the reported AP (e.g., nontransmitted BSSID inheritance rules in Beacon, Probe Response). In some embodiments, the BW, punctured channel information, Tx power information of an element in an ML element are same as the BW, punctured channel information, Tx power information of the same element in reported AP's Beacon or transmitted BSSID AP's Beacon where the reported AP and the transmitted BSSID AP are from the same multiple BSSID set. In some embodiments, if a non-AP MLD switches to a new communications/operating channel (i.e., a channel being switched to (also referred to as a switched channel)) per the information through an ML element, the non-AP MLD is not allowed to transmit a PPDU in the switched channel before receiving the Beacon, Probe Response in the switched channel, ML Probe Response for the full information of the switched channel. In some embodiments, in a Beacon frame, the (Extended) Channel Switch Announcement element can be carried in multi-link (ML) element for reported APs. The Beacon frame also carries whether or not the (Extended) Channel Switch Announcement element carries the full information of a new operating channel of the reported AP. If a non-AP MLD figures out that the (Extended) Channel Switch Announcement element does not carry the full information of the new operating channel of a reported AP through a link, the non-AP MLD may send an ML Probe Request in the link to solicit an ML Probe Response through which the full information of the new operating channel of the reported AP is acquired.

An EHT AP that is compatible with an IEEE 802.11be protocol can announce the punctured 20 MHz channels in its operating channel through EHT Operation element. The INACITVE_SUBCHANNELS in TXVECTOR of HE, EHT, non-HT duplicate PPDU may be based on the announced punctured 20 MHz channels where the announced punctured 20 MHz channels need to set as unavailable in INACITVE_SUBCHANNELS. In EHT multi-user (MU) PPDU and non-HT duplicate PPDU, an EHT STA/AP may further puncture the 20 MHz channels that are not in punctured 20 MHz channels announced in the EHT AP's EHT Operation element. The dynamic channel puncture may be allowed for an AP to transmit EHT MU PPDUs to a single STA that solicits responding frame through Trigger frame. The dynamic channel puncture may be allowed for an STA to transmit EHT MU PPDU to the AP that does not solicit immediate acknowledgement. The MU-RTS/CTS (Request To Send/Clear To Send) to protect dynamic channel puncture may not be allowed. To alleviate the above issues associated with Static Channel Puncture, in some embodiments, such channel puncture announcement operation is disallowed. In some embodiments, in EHT MU PPDU to a single destination and non-HT duplicate PPDU that solicits the responding frame, an EHT STA/AP is not allowed to further puncture the 20 MHz channels that are not in punctured 20 MHz channels announced in the AP's EHT Operation element. In some embodiments, MU-RTS/CTS is allowed to protect Transmit opportunity (TXOP) with dynamic channel puncture. In some embodiments, the MU-RTS can further puncture the 20 MHz channels that are not indicated by Disabled Subchannel Bitmap in EHT Operation element.

In some embodiments, in Beacon, Probe Response, the channel width, Tx power information of the subchannel in the new channel (channel being switched to in the future) that does not include punctured 20 MHz channel(s) are announced. In these embodiments, the widest channel width of the new channel is no more than 160 MHz even if the new channel is 320 MHz channel. With this method, the new defined elements are not needed.

In accordance with an embodiment of the invention, a technique for wireless communications involves communicating with a first device that is compatible with a first wireless communications protocol and a second device that is compatible with a second wireless communications protocol and announcing different channel configurations for the first device that is compatible with the first wireless communications protocol and the second device that is compatible with the second wireless communications protocol when performing channel switch.

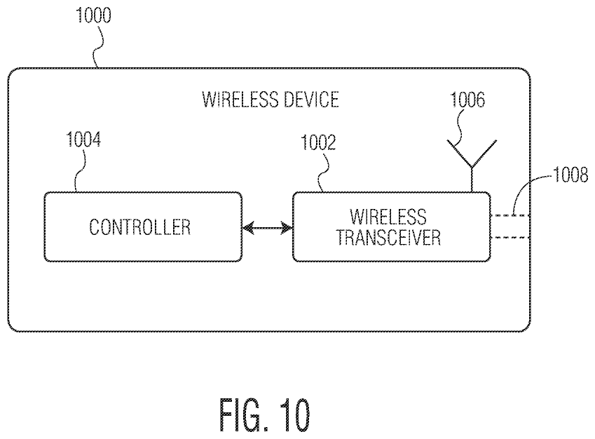

FIG. 10 depicts a wireless device 1000 in accordance with an embodiment of the invention. The wireless device 1000 can be used in the multi-link communications system 100 depicted in FIG. 1. For example, the wireless device 1000 may be an embodiment of the AP 106-1, the AP 106-2, the STA 110-1, and/or the STA 110-2 depicted in FIG. 1. However, the AP 106-1, the AP 106-2, the STA 110-1, and the STA 110-2 depicted in FIG. 1 are not limited to the embodiment depicted in FIG. 10. In the embodiment depicted in FIG. 10, the wireless device 1000 includes a wireless transceiver 1002, a controller 1004 operably connected to the wireless transceiver, and at least one antenna 1006 operably connected to the wireless transceiver. In some embodiments, the wireless device 1000 may include at least one optional network port 1008 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 1000 includes multiple transceivers. The controller may be configured to control the wireless transceiver to process packets received through the antenna and/or the network port and/or to generate outgoing packets to be transmitted through the antenna and/or the network port. In some embodiments, the controller is implemented within a processor, such as a microcontroller, a host processor, a host, a DSP, or a CPU. The antenna may be any suitable type of antenna. For example, the antenna may be an induction type antenna such as a loop antenna or any other suitable type of induction type antenna. However, the antenna is not limited to an induction type antenna. The network port may be any suitable type of port. The wireless device 1000 may be compatible with an IEEE 802.11 protocol (e.g., an 802.11be communication protocol).

In accordance with an embodiment of the invention, the wireless transceiver 1002 is configured to communicate with a first device that is compatible with a first wireless communications protocol and a second device that is compatible with a second wireless communications protocol, and the controller 1004 is configured to announce different channel configurations for the first device that is compatible with the first wireless communications protocol and the second device that is compatible with the second wireless communications protocol when performing channel switch from a current communications/operating channel to a new communications/operating channel. In some embodiments, the controller is configured to announce different channel bandwidth configurations of a channel being switched to for the first device that is compatible with the first wireless communications protocol and the second device that is compatible with the second wireless communications protocol. In some embodiments, the controller is configured to announce different channel puncture configurations of a channel being switched to for the first device that is compatible with the first wireless communications protocol and the second device that is compatible with the second wireless communications protocol when performing channel switch. In some embodiments, the controller is configured to announce different channel transmit power information of a channel being switched to for the first device that is compatible with the first wireless communications protocol and the second device that is compatible with the second wireless communications protocol when performing channel switch. In some embodiments, the controller is configured to announce the different channel configurations for the first device that is compatible with the first wireless communications protocol and the second device that is compatible with the second wireless communications protocol in an Enhanced Wide Bandwidth Channel Switch element. In some embodiments, the controller is configured to announce the different channel configurations for the first device that is compatible with the first wireless communications protocol and the second device that is compatible with the second wireless communications protocol in an Enhanced Channel Switch Wrapper element. In some embodiments, the controller is configured to announce the different channel configurations for the first device that is compatible with the first wireless communications protocol and the second device that is compatible with the second wireless communications protocol in an Enhanced Wide Bandwidth Channel Switch element and in a Wide Bandwidth Channel Switch element. In some embodiments, the controller is configured to announce the different channel configurations for the first device that is compatible with the first wireless communications protocol and the second device that is compatible with the second wireless communications protocol in an Enhanced Channel Switch Wrapper element and in a Channel Switch Wrapper element. In some embodiments, the first wireless communications protocol includes an Institute of Electrical and Electronics Engineers (IEEE) 802.11 protocol. In some embodiments, the first wireless communications protocol includes an IEEE 802.11be protocol. In some embodiments, the wireless device is a component of a multi-link device (MLD). In some embodiments, the wireless device is a wireless access point (AP).

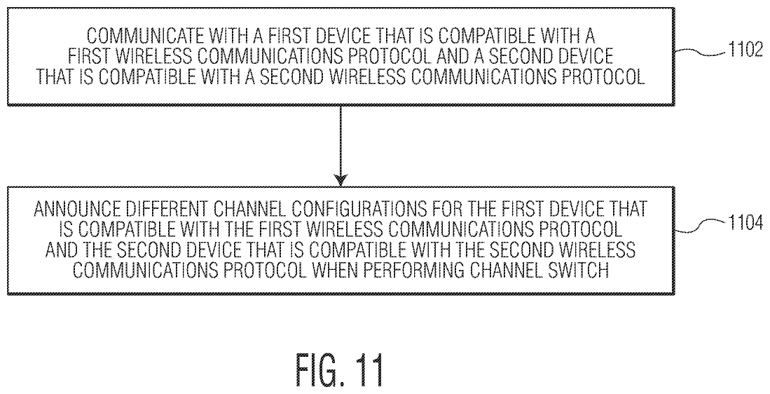

FIG. 11 is a process flow diagram of a method for wireless communications in accordance with an embodiment of the invention. At block 1102, a first device that is compatible with a first wireless communications protocol and a second device that is compatible with a second wireless communications protocol are communicated with. At block 1104, different channel configurations are announced for the first device that is compatible with the first wireless communications protocol and the second device that is compatible with the second wireless communications protocol when performing channel switch. The first device may be the same as or similar to the AP 106-1, the AP 106-2, the STA 110-1, and/or the STA 110-2 depicted in FIG. 1. The second device may be the same as or similar to the AP 106-1, the AP 106-2, the STA 110-1, and/or the STA 110-2 depicted in FIG. 1.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A wireless device comprising:
a wireless transceiver configured to communicate with a first device that is compatible with a first wireless communications protocol and a second device that is compatible with a second wireless communications protocol; and
a controller configured to announce different channel configurations for the first device that is compatible with the first wireless communications protocol and the second device that is compatible with the second wireless communications protocol when performing channel switch.

2. The wireless device of claim 1, wherein the controller is configured to announce different channel bandwidth configurations of a channel being switched to for the first device that is compatible with the first wireless communications protocol and the second device that is compatible with the second wireless communications protocol.

3. The wireless device of claim 1, wherein the controller is configured to announce different channel puncture configurations of a channel being switched to for the first device that is compatible with the first wireless communications protocol and the second device that is compatible with the second wireless communications protocol when performing channel switch.

4. The wireless device of claim 1, wherein the controller is configured to announce different channel transmit power information of a channel being switched to for the first device that is compatible with the first wireless communications protocol and the second device that is compatible with the second wireless communications protocol when performing channel switch.

5. The wireless device of claim 1, wherein the controller is configured to announce the different channel configurations for the first device that is compatible with the first wireless communications protocol and the second device that is compatible with the second wireless communications protocol in an Enhanced Wide Bandwidth Channel Switch element.

6. The wireless device of claim 1, wherein the controller is configured to announce the different channel configurations for the first device that is compatible with the first wireless communications protocol and the second device that is compatible with the second wireless communications protocol in an Enhanced Channel Switch Wrapper element.

7. The wireless device of claim 1, wherein the controller is configured to announce the different channel configurations for the first device that is compatible with the first wireless communications protocol and the second device that is compatible with the second wireless communications protocol in an Enhanced Wide Bandwidth Channel Switch element and in a Wide Bandwidth Channel Switch element.

8. The wireless device of claim 1, wherein the controller is configured to announce the different channel configurations for the first device that is compatible with the first wireless communications protocol and the second device that is compatible with the second wireless communications protocol in an Enhanced Channel Switch Wrapper element and in a Channel Switch Wrapper element.

9. The wireless device of claim 1, wherein the first wireless communications protocol comprises an Institute of Electrical and Electronics Engineers (IEEE) 802.11 protocol.

10. The wireless device of claim 1, wherein the first wireless communications protocol comprises an Institute of Electrical and Electronics Engineers (IEEE) 802.11be protocol.

11. The wireless device of claim 1, wherein the wireless device is a component of a multi-link device (MILD).

12. The wireless device of claim 1, wherein the wireless device is a wireless access point (AP).

13. A wireless access point (AP) of a first multi-link device (MILD) comprising:
a wireless transceiver configured to receive and transmit communications data with a first device that is compatible with a first Institute of Electrical and Electronics Engineers (IEEE) 802.11 protocol and a second device that is compatible with a second IEEE 802.11 protocol of a second MLD; and
a controller configured to announce different channel configurations of a channel being switched to for the first device that is compatible with the first IEEE 802.11 protocol and the second device that is compatible with the second IEEE 802.11 protocol when performing channel switch.

14. The wireless device of claim 13, wherein the controller is configured to announce different channel bandwidth configurations of the channel being switched to for the first device that is compatible with the first IEEE 802.11 protocol and the second device that is compatible with the second IEEE 802.11 protocol.

15. The wireless device of claim 13, wherein the controller is configured to announce different channel puncture configurations of the channel being switched to for the first device that is compatible with the first IEEE 802.11 protocol and the second device that is compatible with the second IEEE 802.11 protocol when performing channel switch.

16. The wireless device of claim 13, wherein the controller is configured to announce different channel transmit power information of the channel being switched to for the first device that is compatible with the first IEEE 802.11 protocol and the second device that is compatible with the second IEEE 802.11 protocol when performing channel switch.

17. The wireless device of claim 13, wherein the controller is configured to announce the different channel configurations of the channel being switched to for the first device that is compatible with the first IEEE 802.11 protocol and the second device that is compatible with the second IEEE 802.11 protocol in an Enhanced Wide Bandwidth Channel Switch element.

18. The wireless device of claim 13, wherein the controller is configured to announce the different channel configurations of the channel being switched to for the first device that is compatible with the first IEEE 802.11 protocol and the second device that is compatible with the second IEEE 802.11 protocol in an Enhanced Channel Switch Wrapper element.

19. A method for wireless communications, the method comprising:
communicating with a first device that is compatible with a first wireless communications protocol and a second device that is compatible with a second wireless communications protocol; and
announcing different channel configurations for the first device that is compatible with the first wireless communications protocol and the second device that is compatible with the second wireless communications protocol when performing channel switch.

20. The method of claim 19, wherein announcing the different channel configurations for the first device that is compatible with the first wireless communications protocol and the second device that is compatible with the second wireless communications protocol when performing channel switch comprises announcing different channel bandwidth configurations of a channel being switched to for the first device that is compatible with the first wireless communications protocol and the second device that is compatible with the second wireless communications protocol.
